(19) United States
(12) Patent Application Publication
(10) Pub. No.: US 2023/0111871 A1
(43) Pub. Date: Apr. 13, 2023

(54) FOUNDATION MODEL BASED FLUID SIMULATIONS

(71) Applicant: DEEP FOREST SCIENCES, INC., Palo Alto, CA (US)

(72) Inventors: BHARATH RAMSUNDAR, Palo Alto, CA (US); VENKATASUBRAMANIAN VISWANATHAN, Mountain View, CA (US)

(73) Assignee: DEEP FOREST SCIENCES, INC., Palo Alto, CA (US)

(21) Appl. No.: 17/963,814

(22) Filed: Oct. 11, 2022

Related U.S. Application Data
(60) Provisional application No. 63/254,309, filed on Oct. 11, 2021.

(51) Int. Cl. G06F 30/27

(52) U.S. Cl. CPC G06F 30/27; G06F 2113/08

(57) ABSTRACT

Apparatuses, systems, computer program products, and methods are disclosed for foundation model based fluid simulations. An apparatus includes a processor and a memory that stores code executable by the processor to receive a fluid foundation model that is pretrained on fluid data, deploy the received fluid foundation model into a downstream machine learning pipeline for a fluid dynamics application, reconfigure the fluid foundation model for the fluid dynamics application, and output results from the machine learning pipeline for the fluid dynamics application based on the reconfigured fluid foundation model.

### CROSS-REFERENCE TO RELATED APPLICATIONS

This application claims the benefit of U.S. Provisional Patent Application No. 63/254,309 entitled “FLUID AND ACOUSTIC FOUNDATION MODELS FOR EFFECTIVE AND EFFICIENT FLUID SIMULATIONS” and filed on Oct. 11, 2021, for Bharath Ramsundar et al., which is incorporated herein by reference in its entirety.

### FIELD

This subject matter herein relates to physical systems and more particularly relates to fluid and acoustic foundation models for fluid simulations.

### BACKGROUND

The field of computational fluid dynamics (“CFD”) uses numerical methods to model fluid flow relevant for several engineering applications. CFD methods, however, suffer from the challenges of large computational cost, leading to slow turnarounds and iteration times, which limit their applications to limited classes of design problems.

### SUMMARY

Apparatuses, systems, computer program products, and methods are disclosed for foundation model based fluid simulations.

In one embodiment, an apparatus includes a processor and a memory that stores code executable by the processor to receive a fluid foundation model that is pretrained on fluid data, deploy the received fluid foundation model into a downstream machine learning pipeline for a fluid dynamics application, reconfigure the fluid foundation model for the fluid dynamics application, and output results from the machine learning pipeline for the fluid dynamics application based on the reconfigured fluid foundation model.

In one embodiment, fluid data includes computational fluid data, experimental fluid data, or some combination thereof.

In one embodiment, fluid data includes three-dimensional fluid mesh data describing one or more meshes that have areas of differing resolutions.

In one embodiment, code is executable by a processor to assign weights of different importance to areas of differing resolutions of one or more meshes during pretraining of a fluid foundation model.

In one embodiment, three-dimensional fluid mesh data includes a vector field describing a velocity and a density of a fluid at each point of a mesh.

In one embodiment, three-dimensional fluid mesh data includes mesh data for one or more meshes that have dynamic resolutions.

In one embodiment, code is executable by a processor to pretrain a fluid foundation model using image processing algorithms by processing fluid data as image data.

In one embodiment, code is executable by a processor to pretrain a fluid foundation model by adding inductive priors during pretraining, the inductive priors include one or more physical constraints associated with fluids.

In one embodiment, inductive priors include one or more equivariance to symmetry groups.

In one embodiment, code is further executable by a processor to receive an acoustic foundation model that is pretrained using acoustic field information.

In one embodiment, code is executable by a processor to pretrain an acoustic foundation model using audio processing algorithms by processing acoustic field information as audio signals.

In one embodiment, code is executable by a processor to deploy an acoustic foundation model into a machine learning pipeline together with a fluid foundation model responsive to a fluid dynamics application having acoustic field properties.

In one embodiment, a fluid dynamics application includes at least one of a vehicle mesh design, a plane design, an electric vertical takeoff and landing aircraft design, and a weather simulation.

In one embodiment, a computer program product includes executable program code stored on a non-transitory computer readable storage medium. In one embodiment, executable program code is executable by a processor to perform operations, including receiving a fluid foundation model that is pretrained on fluid data, deploying the received fluid foundation model into a downstream machine learning pipeline for a fluid dynamics application, reconfiguring the fluid foundation model for the fluid dynamics application, and outputting results from the machine learning pipeline for the fluid dynamics application based on the reconfigured fluid foundation model.

In one embodiment, fluid data includes three-dimensional fluid mesh data describing one or more meshes that have areas of differing resolutions.

In one embodiment, operations further include pretraining a fluid foundation model using image processing algorithms by processing fluid data as image data.

In one embodiment, operations further include pretraining a fluid foundation model by adding inductive priors during pretraining, the inductive priors include one or more physical constraints associated with fluids.

In one embodiment, operations further include receiving an acoustic foundation model that is pretrained using acoustic field information.

In one embodiment, operations further include pretraining an acoustic foundation model using audio processing algorithms by processing acoustic field information as audio signals.

In one embodiment, an apparatus includes means for receiving a fluid foundation model that is pretrained on fluid data, means for deploying the received fluid foundation model into a downstream machine learning pipeline for a fluid dynamics application, means for reconfiguring the fluid foundation model for the fluid dynamics application, and means for outputting results from the machine learning pipeline for the fluid dynamics application based on the reconfigured fluid foundation model/

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for foundation model based fluid simulations;

FIG. 2 is a schematic block diagram illustrating one embodiment of a differentiable machine;

FIG. 3 is a schematic block diagram illustrating one embodiment of a differentiable group;

FIG. 4 is a schematic flow chart diagram illustrating one embodiment of a method for a differentiable machine for a physical system; and

FIG. 5 is a schematic flow chart diagram illustrating another embodiment of a method for a differentiable machine for a physical system.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As discussed in more detail below, the subject matter described herein is directed to using artificial intelligence, and in particular machine learning, to develop fluid simulations and models based on fluid and/acoustic foundation models.

As used herein, artificial intelligence (“AI”) is broadly defined as a branch of computer science dealing in automating intelligent behavior. AI systems maybe designed to use machines to emulate and simulate human intelligence and corresponding behavior. This may take many forms, including symbolic or symbol manipulation AI. AI may address analyzing abstract symbols and/or human readable symbols. AI may form abstract connections between data or other information or stimuli. AI may form logical conclusions. AI is the intelligence exhibited by machines, programs, or software. AI has been defined as the study and design of intelligent agents, in which an intelligent agent is a system that perceives its environment and takes actions that maximize its chances of success.

AI may have various attributes such as deduction, reasoning, and problem solving. AI may include knowledge representation or learning. AI systems may perform natural language processing, perception, motion detection, and information manipulation. At higher levels of abstraction, it may result in social intelligence, creativity, and general intelligence. Various approaches are employed including cybernetics and brain simulation, symbolic, sub-symbolic, and statistical, as well as integrating the approaches.

Various AI tools may be employed, either alone or in combinations. The tools may include search and optimization, logic, probabilistic methods for uncertain reasoning, classifiers and statistical learning methods, neural networks, deep feedforward neural networks, deep recurrent neural networks, deep learning, control theory and languages.

Machine learning (“ML”) plays an important role in a wide range of critical applications with large volumes of data, such as data mining, natural language processing, image recognition, voice recognition and many other intelligent systems. There are some basic common threads about the definition of ML. As used herein, ML is defined as the field of study that gives computers the ability to learn without being explicitly programmed. For example, predicting traffic patterns at a busy intersection, it is possible to run through a machine learning algorithm with data about past traffic patterns. The program can correctly predict future traffic patterns if it learned correctly from past patterns.

There are different ways an algorithm can model a problem based on its interaction with the experience, environment, or input data. The machine learning algorithms may be categorized so that it helps to think about the roles of the input data and the model preparation process leading to correct selection of the most appropriate category for a problem to get the best result. Known categories are supervised learning, unsupervised learning, semi-supervised learning, and reinforcement learning.
(a) In supervised learning category, input data is called training data and has a known label or result. A model is prepared through a training process where it is required to make predictions and is corrected when those predictions are wrong. The training process continues until the model achieves a desired level of accuracy on the training data. Example problems are classification and regression.
(b) In unsupervised learning category, input data is not labelled and does not have a known result. A model is prepared by deducing structures present in the input data. Example problems are association rule learning and clustering. An example algorithm is k-means clustering.
(c) Semi-supervised learning falls between unsupervised learning (without any labeled training data) and supervised learning (with completely labeled training data). Researchers found that unlabeled data, when used in conjunction with a small amount of labeled data may produce considerable improvement in learning accuracy.
(d) Reinforcement learning is another category which differs from standard supervised learning in that correct input/output pairs are never presented. Further, there is a focus on on-line performance, which involves finding a balance between exploration for new knowledge and exploitation of current knowledge already discovered.

Certain machine learning techniques are widely used and are as follows: Decision tree learning, Association rule learning, Artificial neural networks, Inductive logic programming, Support vector machines, Clustering, Bayesian networks, Reinforcement learning, Representation learning, and Genetic algorithms.

The learning processes in machine learning algorithms are generalizations from past experiences. After having experienced a learning data set, the generalization process is the ability of a machine learning algorithm to accurately execute on new examples and tasks. The learner needs to build a general model about a problem space enabling a machine learning algorithm to produce sufficiently accurate predictions in future cases. The training examples come from some generally unknown probability distribution.

In theoretical computer science, computational learning theory performs computational analysis of machine learning algorithms and their performance. The training data set is limited in size and may not capture all forms of distributions in future data sets. The performance is represented by probabilistic bounds. Errors in generalization are quantified by bias-variance decompositions. The time complexity and feasibility of learning in computational learning theory describes a computation to be feasible if it is done in polynomial time. Positive results are determined and classified when a certain class of functions can be learned in polynomial time whereas negative results are determined and classified when learning cannot be done in polynomial time.

As it relates to the subject matter herein, in one embodiment, a foundation model is an AI model that is trained on unlabeled data at scale, usually by self-supervised learning, resulting in a model that can be adapted to a wide range of downstream tasks. The solutions proposed below are directed to building scientific foundation models that can compress large amounts of simulation and experimental data into an efficiently queryable and usable format for computational fluid dynamics. Fluid foundation models may have downstream impacts on the field of computational fluid dynamics for weather prediction, vehicle shape optimization, and/or the like.

A fluid foundation model, as used herein, is a large neural model pretrained on computational and experimental fluid data to learn common patterns of fluid dynamics. The patterns learned by the fluid foundation model serve as compact representations of fluid behavior that capture rich priors about fluid dynamics. These fluid foundation models can be plugged into downstream solvers for fluid dynamics to yield accelerated simulations without any compromise in accuracy in describing fluid dynamical behavior.

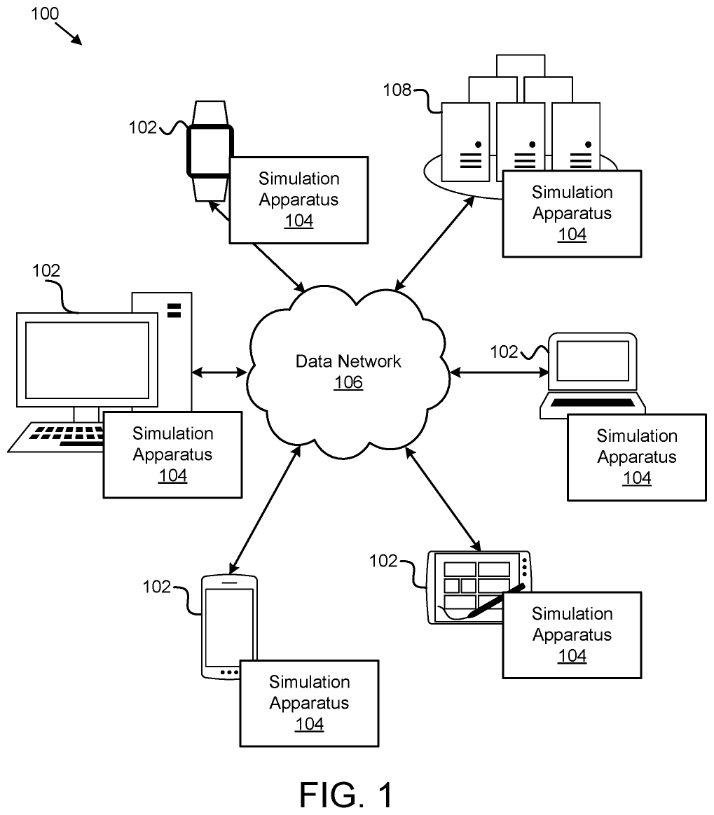

FIG. 1 is a schematic block diagram illustrating one embodiment of a system 100 for foundation model based fluid simulations. In one embodiment, the system 100 includes one or more information handling devices 102, one or more simulation apparatuses 104, one or more data networks 106, and one or more servers 108. In certain embodiments, even though a specific number of information handling devices 102, simulation apparatuses 104, data networks 106, and servers 108 are depicted in FIG. 1, one of skill in the art will recognize, in light of this disclosure, that any number of information handling devices 102, simulation apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, are configured to execute various programs, program code, applications, instructions, functions, and/or the like, which may access, store, download, upload, and/or the like data located on one or more servers 108. The information handling devices 102 may include one or more hardware and software components for training, implementing, deploying, and processing fluid foundation models and corresponding data.

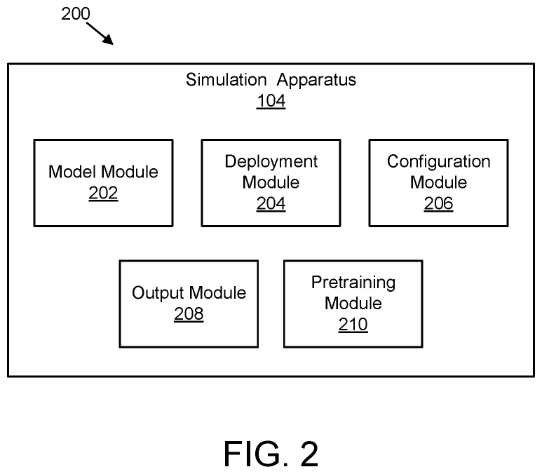

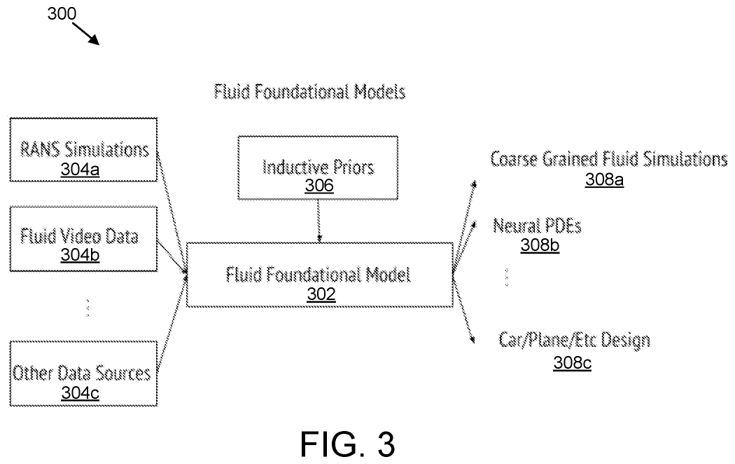

In general, the simulation apparatus 104 is configured to deploy a pretrained fluid foundation model into a downstream machine learning pipeline for a fluid dynamics application, reconfigure or update the fluid foundation model for the fluid dynamics application, and output the results from the machine learning pipeline based on the reconfigured fluid foundation model. The simulation apparatus 104, including its various sub-modules, may be located on one or more information handling devices 102 in the system 100, one or more servers 108, one or more network devices, and/or the like. The simulation apparatus 104 is described in more detail below with reference to FIGS. 2 and 3.

In various embodiments, the simulation apparatus 104 may be embodied as a hardware appliance that can be installed or deployed on an information handling device 102, on a server 108, or elsewhere on the data network 106. In certain embodiments, the simulation apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the simulation apparatus 104 may include a power interface, a wired and/or wireless network interface, a graphical interface that attaches to a display, and/or a semiconductor integrated circuit device as described below, configured to perform the functions described herein with regard to the simulation apparatus 104.

The simulation apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the simulation apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the simulation apparatus 104.

The semiconductor integrated circuit device or other hardware appliance of the simulation apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the simulation apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (IEEE) 802.11 standards. Alternatively, the wireless connection may be a Bluetooth® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (IrPHY) as defined by the Infrared Data Association® (IrDA®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102.

FIG. 2 depicts one embodiment of an apparatus 200 for foundation model based fluid simulations. In one embodiment, the apparatus 200 includes an embodiment of a simulation apparatus 104. The simulation apparatus 104, in one embodiment, includes a model module 202, a deployment module 204, a configuration module 206, an output module 208, and a pretraining module 210, which are described in more detail below.

In one embodiment, the model module 202 is configured to receive a fluid foundation model that is pretrained on fluid data. In one embodiment, the fluid foundation model may be a model that is designed, developed, generated, or the like for a fluid dynamics application, issue, problem, or the like. The model module 202 may generate the model itself, may receive the model from a remote location, e.g., a model data store, and/or the like. In one embodiment, the foundation model, as described below, is pretrained using fluid data

In one embodiment, the deployment module 204 is configured to deploy the received fluid foundation model into a downstream machine learning pipeline for a fluid dynamics application. For instance, in one embodiment, the fluid dynamics application may include a vehicle mesh design, a plane design, an electric vertical takeoff and landing aircraft design, a weather simulation, and/or the like. These are examples of applications that are dependent on fluid dynamics and for which the application of fluid foundation models as described herein are applicable to increase the efficacy, efficiency, and accuracy of the machine learning pipeline.

In one embodiment, the configuration module 206 is configured to reconfigure the fluid foundation model for the fluid dynamics application. In such an embodiment, because the fluid foundation model is pretrained using fluid data from various sources that may be applicable to various applications in general, but none in particular, the configuration module 206 refines, retrains, and/or otherwise configures the fluid foundation model for the particular fluid dynamics application that the machine learning pipeline is designed for.

For example, if the fluid dynamics application is for generating a car design, the configuration module 206 may reconfigure, retrain, refine, or the like the fluid foundation model using data points or other input for the particular application so that the fluid foundation model becomes a model that is customized or designed for the particular goal or desired result, e.g., the design of a vehicle.

In one embodiment, the output module 208 is configured to output results from the machine learning pipeline for the fluid dynamics application based on the reconfigured fluid foundation model. For instance, the machine learning pipeline may generate data sets of predictions, estimates, forecasts, data points, or the like for the fluid dynamics application or problem that is being solved, e.g., a vehicle design, a weather pattern, and/or the like. The output module 208 may provide a raw set of data, data on a graphical interface, and/or the like.

In one embodiment, the pretraining module 210 is configured to pretrain the fluid foundation model using fluid data. The fluid data, as used herein, may include data sets comprising fluid-related date, e.g., fluid dynamic data, that may include computational fluid data, experimental fluid data, and/or the like.

For instance, the fluid data may include three-dimensional fluid mesh data describing one or more meshes that have areas of differing resolutions. Mesh data may be useful when modeling fluids, e.g., air, that travels over a surface, e.g., a wing of an aircraft. In such an embodiment, the three-dimensional fluid mesh data comprises a vector field describing a velocity and a density of a fluid at each point of the mesh. As such, different areas of the design, e.g., different areas of the wing, may require more specific or higher resolutions (e.g. more data points), e.g., areas where turbulence may be high as opposed to other areas that may require less specific or lower resolutions (e.g., less data points). Accordingly, the pretraining module 210 may assign weights of different importance (e.g., higher weights to areas/meshes that required higher resolutions, lower weights to areas/meshes that require lower resolutions) to the areas of differing resolutions of the one or more meshes during pretraining of the fluid foundation model.

In further embodiments, the three-dimensional fluid mesh data includes mesh data for one or more meshes that have dynamic or adaptive resolutions. Dynamic resolution meshes may refer to meshes that apply to surfaces that change. For example, weather simulation applications may use dynamic mesh data to model weather patterns/climate of the Earth, which may change over time causing the mesh data that is used to simulate the Earth's weather patterns to also change.

For some fluid flows, especially turbulent flows, it may be important to model the flow as occurring on an arbitrary mesh structure. In this case, the fluid foundation model may be trained as a graph transformer (a graph neural network that can generate new graph structures based on the original graph, e.g., mesh), and pretraining may involve the prediction of fluid flow behavior at held-out nodes in the mesh or the prediction of fluid flow on held-out subgraphs of the mesh. Subgraphs may be limited to a single time step or may stretch across meshes for different times. Meshes may change at different time steps, so an alternative pretraining methodology could require prediction of mesh changes from time step to time step.

In one embodiment, the pretraining module 210 may use one or more image processing algorithms to process the fluid data as image data for (self-supervised) pretraining of the fluid foundation model. In such an embodiment, the pretraining module 210 may treat the fluid data, which represents different fluid flows, as a series of images, which allows the pretraining module 210 to process the fluid data using various image processing algorithms, such as computer vision, within a machine learning environment, e.g., using computer vision technologies such as convolutional networks or vision transformers. As used herein, a transformer is a deep learning model that adopts the mechanism of self-attention, differentially weighting the significance of each part of the input data. Accordingly, a vision transformer is a transformer that is targeted at vision processing tasks such as image recognition.

The pretraining module 210 may utilize other image processing/computer vision techniques to process the fluid data for pretraining the fluid foundation model including colorization, image patch assembly, frame ordering, inpainting, and corruption classification. Further, the pretraining module 210 may utilize various transformers including vision transformers that are pretrained with masked language modeling techniques. In this manner, by treating the fluid data as an image or video, the pretraining module 210 can adapt the various image processing techniques to fluid data to pretrain the fluid foundation model.

In one embodiment, the pretraining module 210 pretrains the fluid foundation model by adding inductive priors during pretraining. In such an embodiment, the inductive priors include one or more physical constraints associated with fluids. Because fluids satisfy several physical constraints such as conservation of mass, conservation of momentum, or the like, the pretraining module 210 can utilize these physical constraints as pretraining tasks for the fluid foundation model or can alternatively encode the physical constraints into the model architecture as an inductive prior. For example, in one embodiment, a divergence free constraint (conservation of mass) can be realized through a simple linear transformation in Fourier space.

In one embodiment, the inductive priors include equivariance to symmetry groups. In terms of machine learning, equivariance may refer to the property that, given an input, if the input is transformed or changed through some operator, e.g., convolutions, the output is also transformed in a predictable manner. Accordingly, equivariance to symmetry groups may include groups of transformations that act symmetrically on the input data. Examples may include the rotation group SO(3) or the Euclidean group E(3). Encoding these equivariances may help lower data requirements during training and pretraining.

In further embodiments, the model module 202 receives an acoustic foundation model that is pretrained using acoustic field information. In such an embodiment, the pretraining module 210 pretrains the acoustic foundation model using audio processing algorithms by processing the acoustic field information as audio signals and the deployment module 204 deploy the acoustic foundation model into the machine learning pipeline together with the fluid foundation model responsive to the fluid dynamics application having acoustic field properties.

For instance, in one embodiment, the coupling of fluid flow, aerodynamic considerations, and acoustics determine usability in urban air mobility and supersonic plane design. In such an embodiment, acoustic field data is modeled as audio signals and a large pretrained acoustic foundation model is paired with the fluid foundation model to treat the multi-physics coupling of fluid and acoustic fields for the fluid dynamics application.

The fluid dynamics application, in one embodiment, may include an automatic car mesh design. In such an embodiment, constructing generative models of complex car geometries has proven challenging since prospective geometries require expensive simulations to validate. Combining with a fluid foundation model will enable rapid iteration.

In another embodiment, the fluid dynamic application may include a plane design. In such an embodiment, considerable interest has emerged in the creation of supersonic planes which emit low sonic booms. However, such designs have proven prohibitively challenging due to the expensive simulation work needed to validate and due to the insufficient accuracy of existing simulation tools. Fluid and acoustic foundation models solve both challenges by allowing for rapid and efficient queries of supersonic boom profile for a given aircraft design.

In another embodiment, the fluid dynamic application may include an electric vertical take-off and landing (“eVTOL”) aircraft design, which is intended to operate in urban environments and currently, the noise profile is a significant barrier to their adoption. Pairing fluid and acoustic foundation models will allow aircraft design optimization along with the noise profile.

In yet another embodiment, the fluid dynamic application may include large scale simulations of weather that have proven very challenging to perform due to the inability to run simulations at the resolution required. A fluid foundation model can serve as a rich prior to feed into a large weather simulation to accelerate weather (or climate) analysis.

FIG. 3 depicts one embodiment of a schematic block diagram showing the deployment of a fluid foundation model 302 within a machine learning pipeline 300. In one embodiment, the pretraining module 210 uses one or more fluid data sources (collectively 304), such as Reynolds-Averaged Navier-Stokes (“RANS”) simulation data 304a, fluid video data 304b, and/or other data sources 304c, together with indictive prior data 306, to pretrain the fluid foundation model 302. Once deployed in the machine learning pipeline 300, the fluid foundation model 302 can be configured or reconfigured using data for a particular application (collectively 308) such as coarse grained fluid simulations 308a, neural partial differential equations 308b, vehicle design 308c, and/or the like.

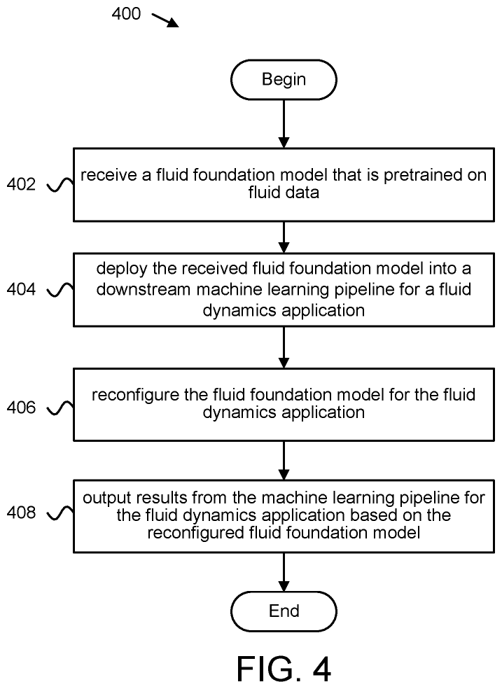

FIG. 4 depicts one embodiment of a method 400 for foundation model based fluid simulations. In one embodiment, the method 400 begins and receives 402 a fluid foundation model that is pretrained on fluid data. In one embodiment, the method 400 deploys 404 the received fluid foundation model into a downstream machine learning pipeline for a fluid dynamics application. In one embodiment, the method 400 reconfigures 406 the fluid foundation model for the fluid dynamics application. In one embodiment, the method 400 outputs 408 results from the machine learning pipeline for the fluid dynamics application based on the reconfigured fluid foundation model, and the method 400 ends.

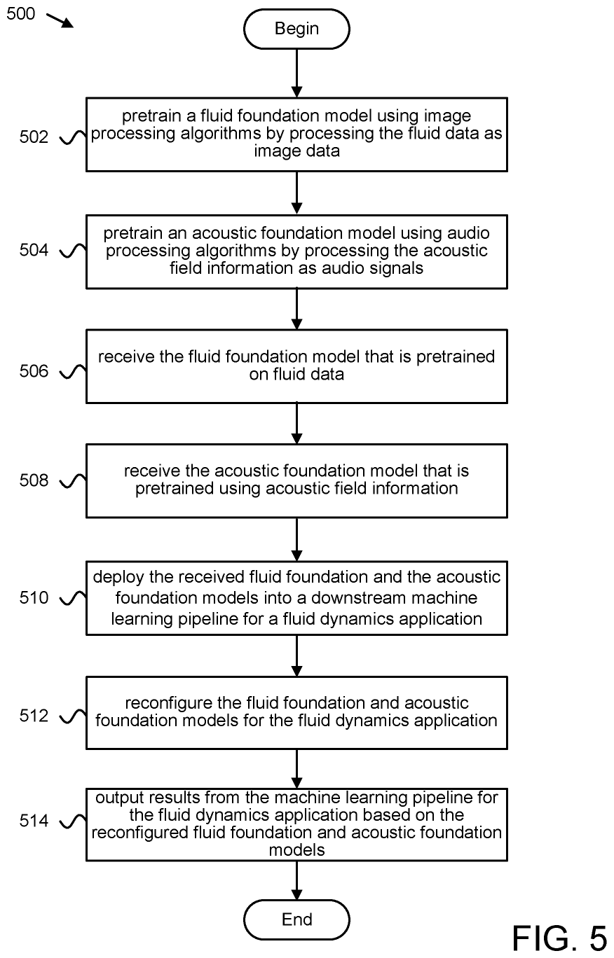

FIG. 5 depicts one embodiment of a method 500 for foundation model based fluid simulations. In one embodiment, the method 500 begins and pretrains 502 a fluid foundation model using image processing algorithms by processing the fluid data as image data. In one embodiment, the method 500 pretrains 504 an acoustic foundation model using audio processing algorithms by processing the acoustic field information as audio signals.

In one embodiment, the method 500 receives 506 the fluid foundation model that is pretrained on fluid data. In one embodiment, the method 500 receives 508 the acoustic foundation model that is pretrained using acoustic field information. In one embodiment, the method 500 deploys 510 the received fluid foundation model and the received acoustic foundation model into a downstream machine learning pipeline for a fluid dynamics application, which may have acoustic field properties.

In one embodiment, the method 500 reconfigures 512 the fluid foundation model and the acoustic foundation model for the fluid dynamics application. In one embodiment, the method 500 outputs 514 the results from the machine learning pipeline for the fluid dynamics application based on the reconfigured fluid foundation and acoustic foundation models, and the method 500 ends.

A means for determining a plurality of differentiable models 202 each representing a component of a physical system 114, in various embodiments, may include one or more of a hardware computing device 102, a hardware server device 108, a differentiable machine module 104, a processor, a CPU, a processor core, an FPGA, other programmable logic, an ASIC, a controller, a microcontroller, a semiconductor integrated circuit device, and/or another hardware device or other computer executable code stored in a non-transitory computer readable storage medium. Other embodiments may comprise similar or equivalent means for determining a plurality of differentiable models 202 each representing a component of a physical system 114.

A means for receiving a fluid foundation model that is pretrained on fluid data, in various embodiments, may include one or more of a hardware computing device 102, a hardware server device 108, a simulation apparatus 104, a model module 202, a processor, a CPU, a processor core, an FPGA, other programmable logic, an ASIC, a controller, a microcontroller, a semiconductor integrated circuit device, and/or another hardware device or other computer executable code stored in a non-transitory computer readable storage medium. Other embodiments may comprise similar or equivalent means for receiving a fluid foundation model that is pretrained on fluid data.

A means for deploying the received fluid foundation model into a downstream machine learning pipeline for a fluid dynamics application, in various embodiments, may include one or more of a hardware computing device 102, a hardware server device 108, a simulation apparatus 104, a deployment module 204, a data network 106, a processor, a CPU, a processor core, an FPGA, other programmable logic, an ASIC, a controller, a microcontroller, a semiconductor integrated circuit device, and/or another hardware device or other computer executable code stored in a non-transitory computer readable storage medium. Other embodiments may comprise similar or equivalent means for deploying the received fluid foundation model into a downstream machine learning pipeline for a fluid dynamics application.

A means for reconfiguring the fluid foundation model for the fluid dynamics application, in various embodiments, may include one or more of a hardware computing device 102, a hardware server device 108, a simulation apparatus 104, a configuration module 206, a data network 106, a sensor, a camera or other optical sensor, a microphone, a thermometer, a barometer, a speedometer, a radar, a lidar, a scale, an accelerometer, a motion sensor, an infrared sensor, a medical sensor, a processor, a CPU, a processor core, an FPGA, other programmable logic, an ASIC, a controller, a microcontroller, a semiconductor integrated circuit device, and/or another hardware device or other computer executable code stored in a non-transitory computer readable storage medium. Other embodiments may comprise similar or equivalent means for reconfiguring the fluid foundation model for the fluid dynamics application.

A means for outputting results from the machine learning pipeline for the fluid dynamics application based on the reconfigured fluid foundation model, in various embodiments, may include one or more of a hardware computing device 102, a hardware server device 108, a simulation apparatus 104, an output module 208, a processor, a CPU, a processor core, an FPGA, other programmable logic, an ASIC, a controller, a microcontroller, a semiconductor integrated circuit device, and/or another hardware device or other computer executable code stored in a non-transitory computer readable storage medium. Other embodiments may comprise similar or equivalent means for outputting results from the machine learning pipeline for the fluid dynamics application based on the reconfigured fluid foundation model.

A means for pretraining the fluid foundation model using image processing algorithms by processing the fluid data as image data, in various embodiments, may include one or more of a hardware computing device 102, a hardware server device 108, a simulation apparatus 104, a pretraining module 210, a processor, a CPU, a processor core, an FPGA, other programmable logic, an ASIC, a controller, a microcontroller, a semiconductor integrated circuit device, and/or another hardware device or other computer executable code stored in a non-transitory computer readable storage medium. Other embodiments may comprise similar or equivalent means for pretraining the fluid foundation model using image processing algorithms by processing the fluid data as image data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
receive a fluid foundation model that is pretrained on fluid data;
deploy the received fluid foundation model into a downstream machine learning pipeline for a fluid dynamics application;
reconfigure the fluid foundation model for the fluid dynamics application; and
output results from the machine learning pipeline for the fluid dynamics application based on the reconfigured fluid foundation model.

2. The apparatus of claim 1, wherein the fluid data comprises computational fluid data, experimental fluid data, or some combination thereof.

3. The apparatus of claim 1, wherein the fluid data comprises three-dimensional fluid mesh data describing one or more meshes that have areas of differing resolutions.

4. The apparatus of claim 3, wherein the code is executable by the processor to assign weights of different importance to the areas of differing resolutions of the one or more meshes during pretraining of the fluid foundation model.

5. The apparatus of claim 3, wherein the three-dimensional fluid mesh data comprises a vector field describing a velocity and a density of a fluid at each point of the mesh.

6. The apparatus of claim 3, wherein the three-dimensional fluid mesh data comprises mesh data for one or more meshes that have dynamic resolutions.

7. The apparatus of claim 1, wherein the code is executable by the processor to pretrain the fluid foundation model using image processing algorithms by processing the fluid data as image data.

8. The apparatus of claim 1, wherein the code is executable by the processor to pretrain the fluid foundation model by adding inductive priors during pretraining, the inductive priors comprising one or more physical constraints associated with fluids.

9. The apparatus of claim 1, wherein the inductive priors comprise one or more equivariance to symmetry groups.

10. The apparatus of claim 1, wherein the code is further executable by the processor to receive an acoustic foundation model that is pretrained using acoustic field information.

11. The apparatus of claim 10, wherein the code is executable by the processor to pretrain the acoustic foundation model using audio processing algorithms by processing the acoustic field information as audio signals.

12. The apparatus of claim 10, wherein the code is executable by the processor to deploy the acoustic foundation model into the machine learning pipeline together with the fluid foundation model responsive to the fluid dynamics application having acoustic field properties.

13. The apparatus of claim 1, wherein the fluid dynamics application comprises at least one of a vehicle mesh design, a plane design, an electric vertical takeoff and landing aircraft design, and a weather simulation.

14. A computer program product comprising executable program code stored on a non-transitory computer readable storage medium, the executable program code executable by a processor to perform operations, the operations comprising:
receiving a fluid foundation model that is pretrained on fluid data;
deploying the received fluid foundation model into a downstream machine learning pipeline for a fluid dynamics application;
reconfiguring the fluid foundation model for the fluid dynamics application; and
outputting results from the machine learning pipeline for the fluid dynamics application based on the reconfigured fluid foundation model.

15. The computer program product of claim 14, wherein the fluid data comprises three-dimensional fluid mesh data describing one or more meshes that have areas of differing resolutions.

16. The computer program product of claim 14, wherein the operations further comprise pretraining the fluid foundation model using image processing algorithms by processing the fluid data as image data.

17. The computer program product of claim 14, wherein the operations further comprise pretraining the fluid foundation model by adding inductive priors during pretraining, the inductive priors comprising one or more physical constraints associated with fluids.

18. The computer program product of claim 14, wherein the operations further comprise receiving an acoustic foundation model that is pretrained using acoustic field information.

19. The computer program product of claim 17, wherein the operations further comprise pretraining the acoustic foundation model using audio processing algorithms by processing the acoustic field information as audio signals.

20. An apparatus, comprising:
means for receiving a fluid foundation model that is pretrained on fluid data;
means for deploying the received fluid foundation model into a downstream machine learning pipeline for a fluid dynamics application;
means for reconfiguring the fluid foundation model for the fluid dynamics application; and
means for outputting results from the machine learning pipeline for the fluid dynamics application based on the reconfigured fluid foundation model.
